(19) United States
(12) Patent Application Publication
(10) Pub. No.: US 2025/0308783 A1
(43) Pub. Date: Oct. 2, 2025

(54) MULTILAYER CERAMIC ELECTRONIC COMPONENT, AND METHOD OF PRODUCING MULTILAYER CERAMIC ELECTRONIC COMPONENT

(71) Applicant: TAIYO YUDEN CO., LTD., Tokyo (JP)

(72) Inventor: Kana TAMURA, Tokyo (JP)

(21) Appl. No.: 19/074,797

(22) Filed: Mar. 10, 2025

(30) Foreign Application Priority Data
Mar. 28, 2024 (JP) 2024-054880

(51) Int. Cl. H01G 4/12; H01G 4/008; H01G 4/33

(52) U.S. Cl. CPC H01G 4/1227; H01G 4/008; H01G 4/33

(57) ABSTRACT

To provide multilayer ceramic electronic component having excellent life characteristics, multilayer ceramic electronic component includes: dielectric layers containing dielectric material having perovskite structure of general formula ABO_{3-α}; internal electrode layers containing nickel as main component; and first intermediate regions containing copper. According to three-dimensional atom probe analysis performed along first axis, first intermediate regions are regions that are contained in a region where nickel concentration is <70 at % and B-site element concentration is ≥20 at %, and that are sandwiched between first boundary part at which B-site element concentration is 20 at % and second boundary part at which copper concentration peak appears. Copper concentration at copper concentration peak is ≥1.0 at % and ≤5.0 at %. Concentration C calculated by formula (1) is ≥10 at % and <35 at %. In formula (1), C(Cu) represents copper concentration at copper concentration peak, C(B) represents B-site element concentration, and C(A) represents A-site element concentration.

$$C = C ( Cu ) + C ( B ) - C ( A ) \qquad ( 1 )$$

### CROSS-REFERENCE TO RELATED APPLICATION

The present application claims priority under 35 U.S.C. § 119 to Japanese Patent Application No. 2024-054880, filed Mar. 28, 2024, the contents of which are incorporated herein by reference in their entireties.

### BACKGROUND OF THE INVENTION

### Field of the Invention

This disclosure relates to a multilayer ceramic electronic component and a method of producing a multilayer ceramic electronic component.

### Description of the Related Art

A multilayer ceramic electronic component has a structure in which dielectric layers and internal electrode layers are alternately laminated. Examples of the multilayer ceramic electronic component include multilayer ceramic capacitors (MLCCs).

Multilayer ceramic electronic components, such as multilayer ceramic capacitors, are mounted and used in various electronic devices, such as high-frequency communication systems, such as mobile phones, vehicle-mounted electronic controllers, and the like. Therefore, multilayer ceramic electronic components are required to have an improved durability through repeated use by voltage application, i.e., to have an improved lifetime, and studies to this end have been conducted so far (see, for example, Japanese Patent Application Laid-Open Publication No. 2010 052964).

### SUMMARY OF THE INVENTION

An object of the present disclosure is to provide a multilayer ceramic electronic component having excellent lifetime characteristics.

A multilayer ceramic electronic component of the present disclosure includes:
a plurality of dielectric layers laminated along a first axis and containing a perovskite structure dielectric material represented by a general formula ABO_{3-α} (0≤α≤1);
a plurality of internal electrode layers each positioned between those of the dielectric layers that are adjacent to each other along the first axis, the internal electrode layers containing nickel as a main component; and
first intermediate regions positioned between the dielectric layers and the internal electrode layers and containing copper,
wherein according to a three-dimensional atom probe analysis performed from the internal electrode layers to the dielectric layers along the first axis,
   the internal electrode layers are regions in which a nickel concentration is 70 at % or greater, and
   the first intermediate regions are regions that are included in a region in which the nickel concentration is less than 70 at % and a concentration of a B-site element of the general formula ABO_{3-α} (0≤α≤1) is 20 at % or greater, and that are sandwiched between a first boundary part at which the concentration of the B-site element is 20 at % and a second boundary part at which a peak of a copper concentration appears,
wherein the copper concentration at the peak of the copper concentration is 1.0 at % or greater and 5.0 at % or less, and

wherein a concentration C calculated by a formula (1) below is 10 at % or greater and less than 35 at %, where in the formula (1), C(Cu) represents the copper concentration at the peak of the copper concentration, C(B) represents the concentration of the B-site element, and C(A) represents a concentration of an A-site element of the general formula ABO_{3-α} (0≤α≤1).

$$C = C ( Cu ) + C ( B ) - C ( A ) \qquad ( 1 )$$

According to the present disclosure, it is possible to provide a multilayer ceramic electronic component having excellent lifetime characteristics.

### BRIEF DESCRIPTION OF THE DRAWINGS

FIG. 1 is a partial sectioned oblique view illustrating a multilayer ceramic capacitor according to an embodiment of the present disclosure;

FIG. 2 is a cross-sectional view illustrating a multilayer ceramic capacitor according to an embodiment of the present disclosure;

FIG. 3 is a cross-sectional view illustrating a multilayer ceramic capacitor according to an embodiment of the present disclosure;

FIG. 4 is a cross-sectional view illustrating details of an element body according to an embodiment of the present disclosure;

FIG. 5 is a flowchart of a method of producing a multilayer ceramic capacitor according to an embodiment of the present disclosure;

FIG. 6A is a view illustrating a method of producing a multilayer ceramic capacitor according to an embodiment of the present disclosure;

FIG. 6B is a view illustrating a method of producing a multilayer ceramic capacitor according to an embodiment of the present disclosure;

FIG. 7 is an example of measurement results of a three-dimensional atom probe analysis of a multilayer ceramic capacitor obtained in Example 2; and

FIG. 8 is an example of measurement results of a three-dimensional atom probe analysis of a multilayer ceramic capacitor obtained in Example 9.

### DETAILED DESCRIPTION OF THE DISCLOSURE

Embodiments of the present disclosure will be described in detail below. However, the present disclosure is not limited thereto. In this specification and drawings, components having substantially the same functional configuration may be omitted from repeated descriptions by assigning the same reference numerals. Further, in the drawings, mutually orthogonal X, Y, and Z axes are indicated were appropriate. The X, Y, and Z axes define a fixed coordinate system that is fixed to a multilayer ceramic capacitor, which is an example of the multilayer ceramic electronic component. When a multilayer ceramic capacitor, which is an example of the multilayer ceramic electronic component has an approximately rectangular parallelepiped outer shape, the X, Y, and Z axes may correspond to the length, width, and height of the rectangular parallelepiped. The multilayer ceramic electronic component of this embodiment will be described below using a multilayer ceramic capacitor, which is an example of the multilayer ceramic electronic component.

### [Multilayer Ceramic Electronic Component] (1)

### (1) Structure of Multilayer Ceramic Electronic Component

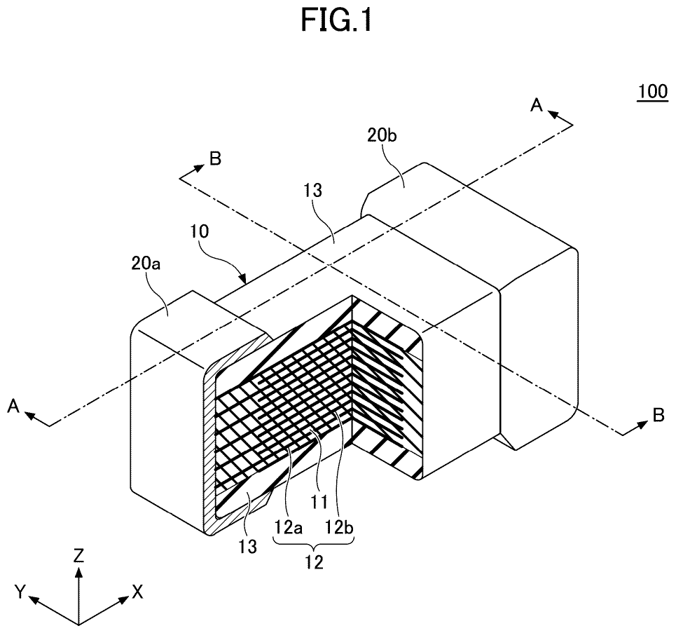

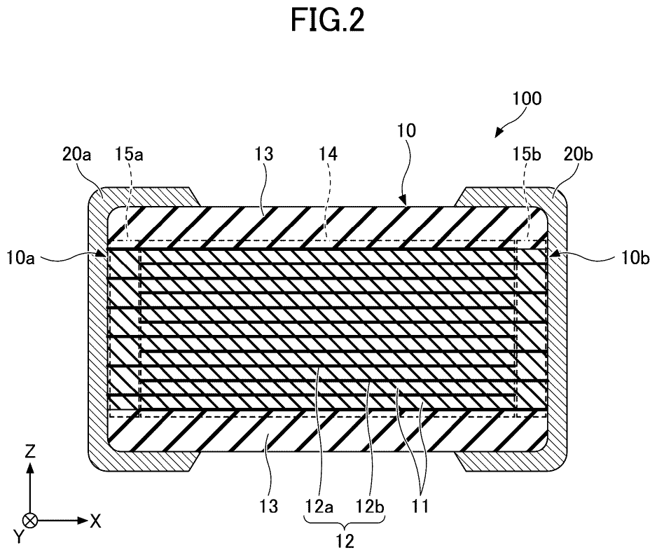

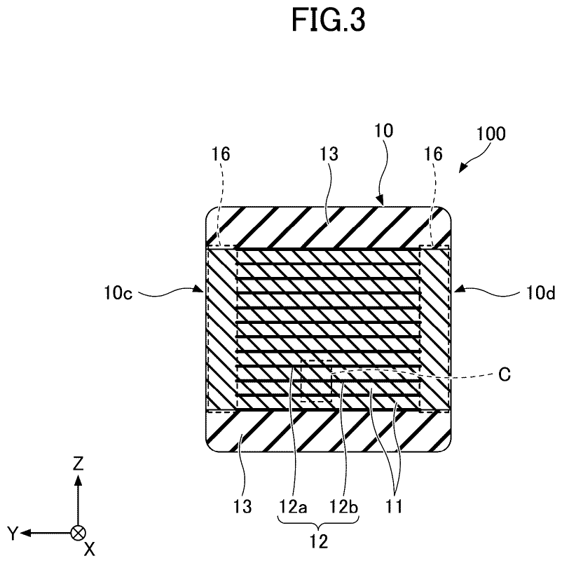

FIG. 1 is a partially sectioned oblique view illustrating a multilayer ceramic capacitor 100. FIGS. 2 and 3 are cross-sectional views illustrating the multilayer ceramic capacitor. FIG. 2 is a cross-sectional view taken along a line A-A in FIG. 1. FIG. 3 is a cross-sectional view taken along a line B-B in FIG. 1. As illustrated in FIGS. 1 to 3, the multilayer ceramic capacitor 100 includes an element body 10 having an approximately rectangular parallelepiped shape. Two surfaces of the element body 10, among surfaces thereof, that face each other are referred to as an upper surface and a lower surface, and four surfaces connecting the upper surface and the lower surface are referred to as side surfaces. Normally, a surface of a multilayer ceramic capacitor that is on a circuit board side when mounting the capacitor on a circuit board is referred to as the lower surface. However, this is non-limiting. In the example of FIGS. 1 to 3, in the element body 10, a first external electrode 20a and a second external electrode 20b are provided on a first side surface 10a and a second side surface 10b (see FIG. 2), which are two facing side surfaces. The first external electrode 20a extends from the first side surface 10a to four adjacent surfaces. The second external electrode 20b extends from the second side surface 10b to four adjacent surfaces. However, the first external electrode 20a and the second external electrode 20b are spaced apart from each other. The external electrodes may be provided on anywhere other than the two facing side surfaces, as long as it is on a surface of the element body 10.

The lamination direction in which dielectric layers 11 and internal electrode layers 12 are laminated is a first axis. In FIGS. 1 to 3, the first axis, which is the lamination direction of the dielectric layers 11 and the internal electrode layers 12, is the Z axis and is a direction in which the internal electrode layers face each other.

An axis perpendicular to the first axis, which is the lamination direction, is a second axis. In FIGS. 1 to 3, the second axis perpendicular to the first axis, which is the lamination direction, is the X axis. The second axis is an axis that is along the length direction of the element body 10, and is along the direction in which the first side surface 10a and the second side surface 10b of the element body 10 face each other, and is along the direction in which the first external electrode 20a and the second external electrode 20b face each other.

An axis that is perpendicular to the first axis, which is the lamination direction, and that is also perpendicular to the second axis is a third axis. The third axis is an axis along the width of the internal electrode layers 12. In FIGS. 1 to 3, the third axis that is perpendicular to the first axis, which is the lamination direction, and that is also perpendicular to the second axis is the Y axis, and is an axis that is along the direction in which a third side surface 10c and a fourth side surface 10d, which are two side surfaces of the element body 10 other than the first side surface 10a and the second side surface 10b, face each other (see FIG. 3). The X axis, the Y axis, and the Z axis are orthogonal to each other.

The lamination direction is not limited to the Z direction, and can be any direction. Therefore, for example, the first axis, which is the lamination direction, may be the X axis in the X direction or the Y axis in the Y direction.

In this specification, a drawing illustrating a specific embodiment among general embodiments may be used for explaining the general embodiments. It is possible to apply the contents described based on the coordinate system used in one embodiment to the general embodiments, by reading the coordinate system of the one embodiment as a general coordinate system in which the lamination direction is the first axis. For example, those that are used in FIGS. 1 to 3 relating to one specific embodiment in which the lamination direction coincides with the Z direction, and that are described as the X axis, Y axis, and Z axis can be applied to general embodiments by being read as the second axis, the third axis, and the first axis.

The element body 10 has a structure in which the dielectric layers 11 containing a ceramic material functioning as a dielectric material and the internal electrode layers 12 are laminated alternately. The internal electrode layers 12 include a plurality of first internal electrode layers 12a and a plurality of second internal electrode layers 12b. The first internal electrode layers 12a and the second internal electrode layers 12b are laminated alternately. The edges of the first internal electrode layers 12a are drawn out to a surface of the element body 10 on which the first external electrode 20a is provided, which is the first side surface 10a in the example of FIGS. 1 to 3. The edges of the second internal electrode layers 12b are drawn out to a surface of the element body 10 on which the second external electrode 20b is provided, which is the second side surface 10b in the example of FIGS. 1 to 3. Thus, the first internal electrode layers 12a and the second internal electrode layers 12b are in alternate electrical conduction to the first external electrode 20a and the second external electrode 20b. Therefore, the multilayer ceramic capacitor 100 has a configuration in which capacitor units are laminated. In the laminate of the dielectric layers 11 and the internal electrode layers 12, internal electrode layers 12 are positioned on the outermost layers in the lamination direction, and the outer surfaces of the laminate in the lamination direction, which are the upper surface and the lower surface in the example of FIGS. 1 to 3, are covered by a cover layer 13. The cover layer 13 is mainly composed of a ceramic material. For example, the cover layer 13 may have a composition that is the same as or different from the dielectric layers 11. The configuration shown in FIGS. 1 to 3 is non-limiting, except that the first internal electrode layers 12a and the second internal electrode layers 12b are exposed to different regions among the surfaces of the laminate and are in electrical conduction with different external electrodes. The different regions among the surfaces of the laminate may be surface regions included in facing surfaces of the laminate, respectively, surface regions included in adjacent surfaces of the laminate, respectively, or may be different surface regions included in the same surface of the laminate. As long as the different external electrodes are spaced apart from each other, the external electrodes may extend from the surfaces of the laminate, which include the surface regions to which the first internal electrode layers 12a and the second internal electrode layers 12b are exposed, to any other surface.

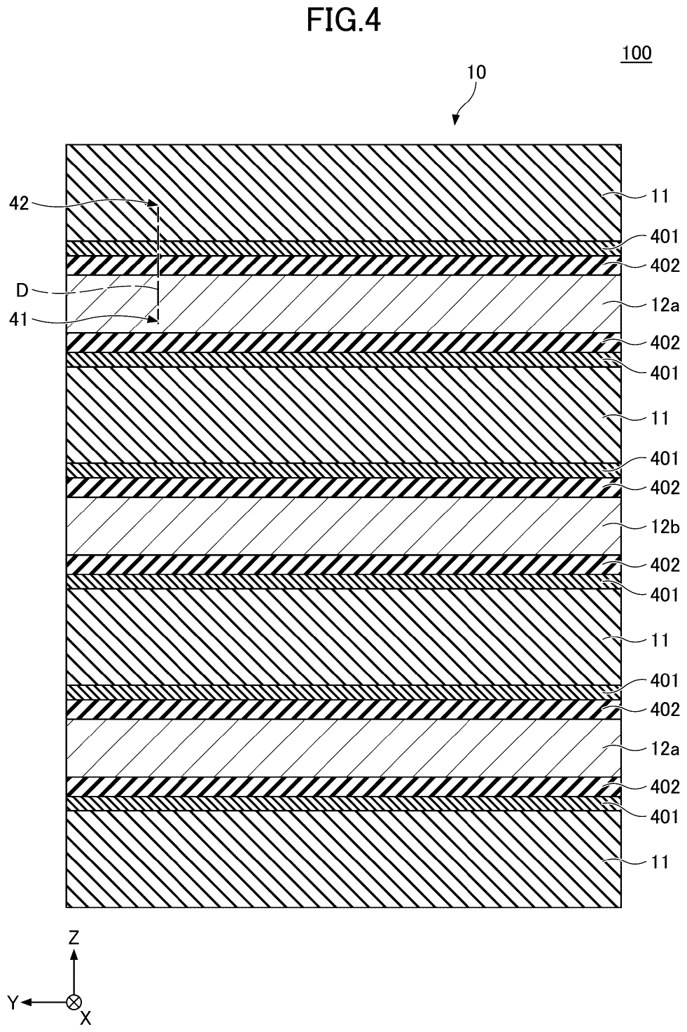

The element body 10 has a plurality of first intermediate regions 401 (see FIG. 4), which will be described in detail below, between the dielectric layers 11 and the internal electrode layers 12. In FIGS. 1 to 3, description of the first intermediate regions 401 is omitted.

The size of the multilayer ceramic capacitor 100 is not particularly limited. For example, it may have a length of 0.25 mm, a width of 0.125 mm, and a height 0.125 mm, or a length of 0.4 mm, a width of 0.2 mm, and a height of 0.2 mm, or a length of 0.6 mm, a width of 0.3 mm, and a height of 0.3 mm, or a length of 1.0 mm, a width of 0.5 mm, and a height of 0.5 mm, or a length of 3.2 mm, a width of 1.6 mm, and a height of 1.6 mm, or a length of 4.5 mm, a width of 3.2 mm, and a height of 2.5 mm. The above listed sizes of the multilayer ceramic capacitor 100 are only examples, and the multilayer ceramic capacitor is not limited to the above sizes. The sizes of the multilayer ceramic capacitor 100 may be in the relationship of, for example, length>width>height, width>length>height, height>length>width, or height>width>length. For example, the length represents the size in the X axis direction, the width represents the size in the Y axis direction, and the height represents the size in the Z axis direction.

As described so far, the multilayer ceramic capacitor 100 of this embodiment includes the plurality of dielectric layers 11 laminated along the Z axis, which is the first axis, and the plurality of internal electrode layers 12 each positioned between those of the dielectric layers 11 that are adjacent to each other along the first axis. Furthermore, the multilayer ceramic capacitor 100 of this embodiment includes the first intermediate regions 401 positioned between the dielectric layers 11 and the internal electrode layers 12. The dielectric layers 11, the internal electrode layers 12, and the first intermediate regions 401 will be described below.

In this specification, there are cases where numbers such as first and second are added to the names of the members like a first intermediate region and a second intermediate region. The numbers are added only to identify the members described and to avoid confusion, and do not indicate priority, positioning, and the like. Therefore, when there is no fear of confusion or when referring to the members collectively, the members may be simply referred to as, for example, the intermediate regions.

### (2) Dielectric Layers

The dielectric layers 11 contain a dielectric material having a perovskite structure represented by a general formula ABO_{3-α} (0≤α≤1).

### (2-1) Components Contained in Dielectric Layers

### (Compound Having Perovskite Structure)

When a compound having a perovskite structure has a stoichiometric composition, a, which represents the amount of deviation from the stoichiometric composition, is zero, so the compound is represented by a general formula ABO₃. A compound having a perovskite structure represented by the general formula above may have α that is greater than 0 and less than or equal to 1. In other words, the compound having a perovskite structure represented by the general formula above may have less oxygen than the amount of oxygen in the stoichiometric composition.

As the compound having a perovskite structure, one or more types selected from barium titanate (BaTiO₃), calcium zirconate (CaZro₃), calcium titanate (CaTio₃), strontium titanate (SrTiO₃), magnesium titanate (MgTiO₃), Ba_{1-x-y}CaₓSr_{y}Ti_{1-z}Zr_{z}O₃ (where 0≤x≤1, 0≤y≤1, 0≤z≤1) forming a perovskite structure, and the like, can be used.

Examples of the Ba_{1-x-y}CaₓSr_{y}Ti₁₋₂Zr_{z}O₃ include barium strontium titanate, barium calcium titanate, barium zirconate, barium zirconate titanate, calcium zirconate titanate, barium calcium zirconate titanate, and the like. The compound having a perovskite structure may contain oxygen deficiency regardless of whatever material it is.

It is preferable that the dielectric layers 11 contain barium titanate as a compound having a perovskite structure because of its particularly excellent dielectric properties, and may contain barium titanate as a main component, or may be composed only of barium titanate. Barium titanate has excellent dielectric properties such as an extremely high dielectric constant, a low dielectric loss, and the like. Therefore, when the dielectric layers 11 contain barium titanate as a compound having a perovskite structure, the capacitance of the multilayer ceramic capacitor 100 can be increased. As used herein, “being contained as a main component” means that being contained the most among the components contained, in terms of the number of moles.

### (Additives)

The dielectric layers 11 may contain additives as optional components.

Additives that can be contained in the dielectric layers 11 are not particularly limited, and examples include oxides containing one or more elements selected from zirconium (Zr), magnesium (Mg), manganese (Mn), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)), oxides containing one or more elements selected from cobalt (Co), nickel (Ni), lithium (Li), boron (B), sodium (Na), potassium (K), and silicon (Si), glass containing one or more elements selected from cobalt, nickel, lithium, boron, sodium, potassium, and silicon, and the like.

### (2-2) Thickness of Dielectric Layers

The thickness of the dielectric layers 11 is not particularly limited, and is, for example, preferably 1.0 μm or less, and more preferably 0.8 μm or less, in order to increase the number of layers to increase the capacitance while reducing the size of the multilayer ceramic capacitor 100.

The lower limit of the thickness of the dielectric layers 11 is not particularly limited. From the viewpoint of improving productivity and yield, the minimum value can be 2 to 4 times the average diameter of the dielectric material particles used. For example, when the average diameter of the dielectric material particles used is 0.1 μm, the lower limit of the thickness of the dielectric layers 11 can be from 0.2 μm or greater to 0.4 μm or greater.

The average diameter of the dielectric material particles can be determined by measuring the particle diameter of each dielectric material particle in a cross-section of the multilayer ceramic capacitor 100 including the first axis that is the same as the lamination direction, and adopting the average of the measured diameters. To measure the particle diameter of the dielectric material particles, an optical microscope, a microscope, a scanning electron microscope (SEM), or the like can be used appropriately. The particle diameter of the dielectric material particles may be the Heywood diameter (i.e., the diameter of a circle having an area equal to the area of the dielectric material particles to be evaluated) in the observed cross-section. The average diameter, which is the average of the particle diameters of the dielectric material particles, may be the arithmetic mean value of the particle diameters of 50 or more and 200 or less arbitrarily selected dielectric material particles.

The thickness of the dielectric layers 11 is evaluated in a cross-section including the first axis that is the same as the lamination direction. For example, it is preferable to evaluate the thickness in a cross-section further including the second axis set to be perpendicular to the lamination direction or in a cross-section further including the third axis set to be perpendicular to the lamination direction and also perpendicular to the second axis, from the viewpoint of ease of polishing and measurement. The multilayer ceramic capacitor 100 is polished in the third axis direction for the former, and is polished in the second axis direction for the latter. Five layers are selected from the center part, and the upper end part, and the lower end part of the exposed dielectric layers 11 in the first axis direction, respectively. When the number of the dielectric layers 11 is even, six layers are selected from the center part. The thickness of each selected dielectric layer is measured at three locations, namely, the center, the left end, and the right end, and the average value of the measured thickness values is used as the thickness of each dielectric layer 11. Then, the average value of the thickness values of all the selected and evaluated dielectric layers 11 can be used as the thickness of the dielectric layers 11 of the multilayer ceramic capacitor 100.

In the example shown in FIGS. 1 and 2, since the first axis, which is the lamination direction, is in the Z axis direction, the multilayer ceramic capacitor 100 is polished along the Y-axis, which is the third axis, and an XZ surface in which the dielectric layers 11 and the internal electrode layers 12 are laminated is exposed.

In this case, in the exposed XZ surface, five dielectric layers 11 located at the center part along the Z axis, which is the first axis, are selected, and each of the five dielectric layers 11 located at the upper end and at the lower end along the Z axis, which is the first axis, are selected. When the number of the dielectric layers 11 is even, six layers may be selected from the center part. Here, the dielectric layers 11 to be selected are selected from a capacitive part 14.

Then, the thickness of each selected dielectric layer 11 is measured along the X axis, which is the second axis, at three locations apart from an end by ¼, ½, and ¾ the length of the dielectric layer 11 along the X axis, and the average value is used as the thickness of the dielectric layer 11. By the same procedure, the thickness of all the selected dielectric layers 11 is measured, and the average value of all the selected and evaluated dielectric layers 11 can be used as the thickness of the dielectric layers 11 of the evaluated multilayer ceramic capacitor 100.

### (3) Internal Electrode Layers

### (3-1) Components Contained in Internal Electrode Layers

As illustrated in FIG. 2, a region in which the first internal electrode layers 12a connected to the first external electrode 20a and the second internal electrode layers 12b connected to the second external electrode 20b face each other is a region where electric capacitance is generated in the multilayer ceramic capacitor 100. Therefore, the region in which electric capacitance is generated is referred to as the capacitive part 14. That is, the capacitive part 14 is a region in which internal electrode layers connected to different external electrodes and adjacent to each other across the dielectric layers 11 face each other.

A region where the first internal electrode layers 12a connected to the first external electrode 20a face each other in the lamination direction via no second internal electrode layers 12b connected to the second external electrode 20b is referred to as a first end margin 15a. A region where the second internal electrode layers 12b connected to the second external electrode 20b face each other in the lamination direction via no first internal electrode layers 12a connected to the first external electrode 20a is referred to as a second end margin 15b. Each end margin is a region where the internal electrode layers connected to the same external electrode face each other in the lamination direction via no internal electrode layers that are connected to a different external electrode. Each of the first end margin 15a and the second end margin 15b is a region where the internal electrodes having the same potential face each other and substantially no electric capacitance is generated.

Side margins 16 are regions provided on the outer side of the capacitive part 14 in a direction along the third axis perpendicular to the lamination direction and also perpendicular to the second axis, which is the Y axis in the example of FIG. 3. That is, the side margins 16 are outer regions adjacent to the capacitive part 14 when viewed in the lamination direction and are outer regions adjacent to the capacitive part 14 on the sides to which the internal electrode layers 12 are not drawn out. The side margins 16 are also regions in which no electric capacitance is generated.

The internal electrode layers 12 contain nickel as a main component. In addition to nickel, the internal electrode layers 12 can contain components used in the internal electrode layers of multilayer ceramic capacitors. In addition to nickel (Ni), the internal electrode layers 12 can also contain base metals such as tin (Sn), tungsten (W), and the like, or alloys containing these metals.

### (3-2) Thickness of Internal Electrode Layers

Although the thickness of the internal electrode layers 12 is not particularly limited, it is preferably, for example, 0.8 μm or less, and more preferably 0.6 μm or less, in order to increase the capacitance by increasing the number of laminated layers while reducing the size of the multilayer ceramic capacitor 100.

The lower limit of the thickness of the internal electrode layers 12 is not particularly limited, and can be 0.4 μm or greater when forming the internal electrode layers 12 by, for example, printing a metal conductive paste by a printing method such as screen printing, gravure printing, and the like. For example, when forming the internal electrode layers 12 by a thin film process such as sputtering, vapor deposition, and the like, the thickness can be equal to or greater than 0.1 μm, which is smaller than in the case of the printing method.

The thickness of the internal electrode layers 12 is evaluated in a cross-section including the first axis that is the same as the lamination direction in the same way as evaluating the thickness of the dielectric layers 11. For example, it is preferable to evaluate the thickness in either a cross-section further including the second axis set to be perpendicular to the lamination direction or a cross-section further including the third axis set to be perpendicular to the lamination direction and also perpendicular to the second axis for ease of polishing and measurement.

Five layers are selected from the center part, and the upper end part and the lower end part of exposed internal electrode layers 12 in the first axis direction. When the number of internal electrode layers 12 is even, six layers are selected from the center part. Then, the thickness of each selected internal electrode layer 12 is measured at three locations, namely, the center, the left end, and the right end, and the average value of the measured thickness values is used as the thickness of each internal electrode layer 12. Furthermore, the average value of the thickness values of all the selected and evaluated internal electrode layers 12 can be used as the thickness of the internal electrode layers 12 of the multilayer ceramic capacitor 100.

In the example shown in FIGS. 1 and 2, since the first axis, which is the lamination direction, is the Z axis direction, the multilayer ceramic capacitor 100 is polished along the Y axis, which is the third axis, to expose an XZ surface in which the dielectric layers 11 and the internal electrode layers 12 are laminated.

In this case, in the exposed XZ surface, five internal electrode layers 12 located in the center along the Z axis, which is the first axis, are selected, and each of five internal electrode layers 12 located at the upper end and at the lower end along the Z axis, which is the first axis, are selected. When the number of the internal electrode layers 12 is even, six layers may be selected from the center. Here, the internal electrode layers 12 to be selected are selected from the capacitive part 14.

Then, the thickness of each selected internal electrode layer 12 is measured along the X axis, which is the second axis, at three locations apart from an end by ¼, ½, and ¾ the length of the internal electrode layer 12 along the X axis, and the average value is used as the thickness of the internal electrode layer 12. By the same procedure, the thickness of all the selected internal electrode layers 12 is measured, and the average value of the thickness values of all the selected and evaluated internal electrode layers 12 can be used as the thickness of the internal electrode layers 12 of the evaluated multilayer ceramic capacitor 100.

### (4) First Intermediate Regions and Second Intermediate Regions

### (4-1) Positioning of First Intermediate Regions and Second Intermediate Regions

FIG. 4 shows a partially enlarged view of the dielectric layers 11 and the internal electrode layers 12 of the element body 10. FIG. 4 is an enlarged view of, for example, a region C of FIG. 3.

The multilayer ceramic capacitor 100 includes first intermediate regions 401 positioned between the dielectric layers 11 and the internal electrode layers 12.

An internal electrode layer 12 and a first intermediate region 401 may be in direct contact with each other, but a second intermediate region 402 may be further provided between the first intermediate region 401 and the internal electrode layer 12.

Since FIG. 4 is a schematic diagram, the first intermediate region 401 and the second intermediate region 402 are illustrated as continuous layers having a constant thickness. However, this configuration is non-limiting. For example, the first intermediate region 401 and the second intermediate region 402 may be discontinuous, and may be varied in thickness depending on the location. Since the first intermediate region 401 can be identified by a three-dimensional atom probe analysis described below, it is not necessary that a clear boundary that can be identified in a SEM image or the like is present between the dielectric layer 11 and the first intermediate region 401 in a cross-section of the multilayer ceramic capacitor 100. The same applies to the boundary between the first intermediate region 401 and the second intermediate region 402, and the boundary between the second intermediate region 402 and the internal electrode layer 12.

The components contained in the first intermediate region 401 and the like will be described in “(5) Method for Identifying Boundary between Layers”.

(5) Method for Identifying Boundary between Layers

The boundaries between the dielectric layer 11, the internal electrode layer 12, the first intermediate region 401, and the second intermediate region 402 can be identified by a three-dimensional atom probe analysis, which can also analyze the amount of elements contained.

The three-dimensional atom probe analysis evaluation can be performed, for example, using a sample including approximately the interface between the dielectric layer 11 and the internal electrode layer 12.

In identifying the boundaries between the layers and analyzing the content ratio of the elements, a three-dimensional atom probe analysis (3DAP) can be performed from the internal electrode layer 12 to the dielectric layer 11 along the Z axis, which is the first axis. That is, for example, the three-dimensional atom probe analysis can be performed using a sample that includes a part extending along the dotted line D of FIG. 4 from a first end 41 included in the internal electrode layer 12 to a second end 42 included in the dielectric layer 11.

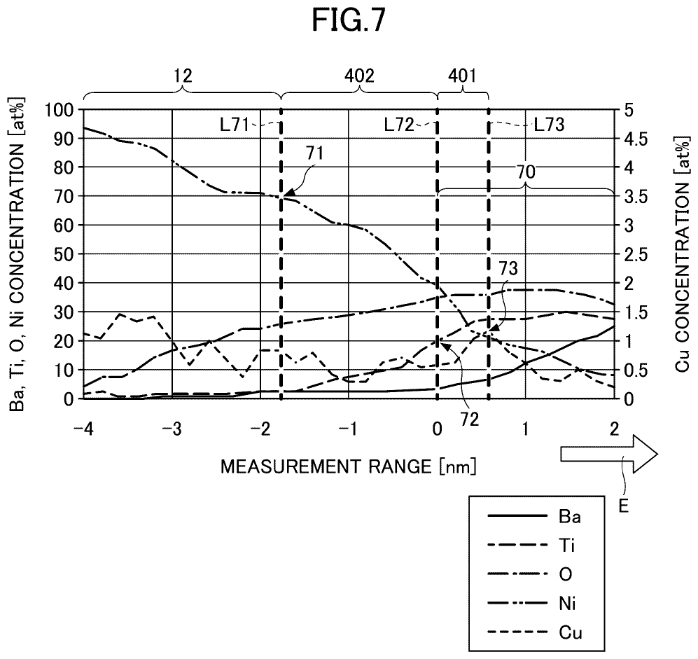

Here, FIG. 7 shows the analysis results of the three-dimensional atom probe analysis in Example 2, which will be described later. In FIG. 7, the vertical axis represents the concentration, that is, the content ratio of each element, of all detected elements. The horizontal axis represents the position of the measurement point along the analyzing direction when the three-dimensional atom probe analysis was performed, while representing the position of a first boundary part 72, which will be described later, as 0.

### (Internal Electrode Layer)

As shown in FIG. 7, the internal electrode layer 12 is a region where the nickel concentration is 70 at % or greater. Therefore, as shown in FIG. 7, the internal electrode layer 12 is a region in which the nickel concentration is 70 at % or greater, and that is bounded by a straight line L71 passing through a point 71 at which the nickel concentration is 70 at %.

### (First Intermediate Region)

The first intermediate region 401 is located within a region 70 where the nickel concentration is less than 70 at % and the concentration of the B-site element of the general formula ABO_{3-α} (0≤α≤1) is 20 at % or greater. Specifically, it is a region, within the region 70, that is sandwiched between a first boundary part at which the concentration of the B-site element is 20 at % and a second boundary part that is on a copper concentration peak 73, which is a peak of the copper concentration. That is, as shown in FIG. 7, the first intermediate region 401 is a region sandwiched between a straight line L72 passing through the first boundary part 72 at which the titanium concentration is 20 at % and a straight line L73 passing through the second boundary part that is on the copper concentration peak 73.

In the following description, the elements A and B other than oxygen contained in the dielectric material represented by the general formula ABO_{3-α} (0≤α≤1) contained in the dielectric layers 11 will be described as an A-site element and a B-site element, respectively.

That is, the first intermediate region 401 is a region containing copper. The first intermediate region 401 is a region containing the B-site element, copper, and oxygen. The states of the B-site element and copper in the first intermediate region 401 are not particularly limited. In the first intermediate region 401, it is assumed that the B-site element and copper form a complex compound such as a complex oxide containing the B-site element and copper. In the first intermediate region 401, the B-site element and copper may exist in one or more of the states selected from the state of simple substances of the elements without forming a compound, the state of forming a complex compound such as a complex oxide containing the B-site element and copper, and the state of both forming compounds with different elements and forming a B-site element compound and a copper compound. For example, the first intermediate region 401 may contain the B-site element and copper in different states from each other, and may contain each of these elements in a plurality of different states such as a simple substance of each element and its compound.

It is considered that positioning the copper-containing first intermediate region 401 between the dielectric layer 11 and the internal electrode layer 12 makes the height of an electrical barrier, that is, a Schottky barrier, between the dielectric layer 11 and the internal electrode layer 12 high. Therefore, when a voltage is applied to the multilayer ceramic capacitor 100, the voltage to be applied to the dielectric layer 11 is attenuated by the first intermediate region 401, making the dielectric layer 11 less likely to be damaged even through repetitive voltage application to the multilayer ceramic capacitor 100. It is considered possible to improve the lifetime of the multilayer ceramic capacitor 100 as a result.

In existing multilayer ceramic capacitors, the dielectric layer may undergo insulation deterioration, in which it loses its electrical insulating property and becomes a conductor, through repetitive voltage application or the like. It is considered that the insulation deterioration is caused by oxygen defects moving from the dielectric layer close to the interface with the internal electrode layer when a voltage is applied, and consequent uneven distribution of oxygen defects near the interface with the internal electrode layer.

In the multilayer ceramic capacitor 100 of this embodiment, the first intermediate region 401 is positioned between the dielectric layer 11 and the internal electrode layer 12. The first intermediate region 401 contains the B-site elements copper, and oxygen. Because the multilayer ceramic capacitor 100 of this embodiment has such a configuration, it is considered that when a voltage is applied to the multilayer ceramic capacitor 100, oxygen defects moving in the dielectric layer 11 can be prevented from moving close to the interface with the internal electrode layer 12 and being unevenly distributed, owing to the presence of the first intermediate region 401. Therefore, occurrence of insulation deterioration can be suppressed, and the lifetime of the multilayer ceramic capacitor 100 can be improved.

The reason why the multilayer ceramic capacitor 100 of this embodiment possessing the first intermediate region 401 can prevent oxygen defects from moving close to the interface with the internal electrode layer 12 and from being unevenly distributed is not clear, but is estimated as follows.

The first intermediate region 401 contains the B-site element, copper, and oxygen. Among these elements, copper is generally considered to function as an oxygen supplier. Therefore, when oxygen defects move from the dielectric layer 11 to the internal electrode layer 12, the oxygen defects are supplied with oxygen from copper in the first intermediate region 401 or with oxygen present in the first intermediate region 401 when the oxygen defects are in the first intermediate region 401 or near the first intermediate region 401, so the oxygen defects are eliminated. That is, it is considered that the oxygen defects are prevented from moving in the first intermediate region 401 or moving near the first intermediate region 401, and that at least some of the oxygen defects are eliminated. As a result, it is estimated that uneven distribution of oxygen defects near the interface with the internal electrode layer 12 can be prevented, and that the lifetime of the multilayer ceramic capacitor 100 can be improved.

From the viewpoint of enhancing the oxygen supply capacity of the first intermediate region 401 and enhancing the lifetime of the multilayer ceramic capacitor 100 in particular, it is preferable that the copper concentration at the copper concentration peak 73 in the first intermediate region 401 is 1.0 at& or greater. However, if the copper concentration at the copper concentration peak 73 is excessively high, the copper concentration in the dielectric layer 11 becomes high, which may risk shortening the lifetime of the multilayer ceramic capacitor 100 to the contrary. Therefore, it is preferable that the copper concentration at the copper concentration peak 73 is 5.0 at % or less. When the first intermediate region 401 contains not only copper but also, for example, a B-site element having a perovskite structure and oxygen, diffusion of copper alone into the dielectric layer 11 is inhibited. The details of the mechanism behind this are yet to be elucidated. However, an assumable possibility is as follows. When copper diffuses, it tends to diffuse to the B-site of the perovskite structure, but the diffusivity of copper is lower than that of the B-site element. Therefore, when the B-site element exists in the first intermediate region 401, its diffusion is prioritized over that of copper, which can inhibit diffusion of copper alone into the dielectric layer 11.

Therefore, it is preferable that the copper concentration at the copper concentration peak 73 according to a three-dimensional atom probe analysis is 1.0 at % or greater and 5.0 at % or less. In particular, from the viewpoint of prolonging the lifetime of the multilayer ceramic capacitor 100, the copper concentration at the copper concentration peak 73 is more preferably 1.2 at % or greater and 3.0 at % or less, and more preferably 2.0 at % or greater and 3.0 at % or less.

The copper concentration peak 73 is a peak at which the copper concentration is locally higher than other parts in the region where the nickel concentration is less than 70 at % and the concentration of the B-site element of the general formula ABO_{3-α} (0≤α≤1) is 20 at % or greater. The presence or absence of the copper concentration peak can be determined by the following procedure. In the determination, first, a three-dimensional atom probe analysis can be performed from the internal electrode layer 12 to the dielectric layer 11 along the first axis.

In the measurement result described above, the point at which the copper concentration assumes the maximum value is extracted from the region described above. Then, when, at the point at which the copper concentration assumes the maximum value, the copper concentration is 1.5 or more times the average value of the copper concentration in a region that is apart from the first boundary part 72 in a direction toward the dielectric layer 11 by +0.5 nm or greater and +2 nm or less, the point at which the copper concentration assumes the maximum value can be determined as the copper concentration peak 73. That is, it can be determined that a copper concentration peak 73 is present.

When, at the point at which the copper concentration assumes the maximum value, the copper concentration is less than 1.5 times the average value of the copper concentration in the region apart from the first boundary part 72 in the direction toward the dielectric layer 11 by +0.5 nm or greater and +2 nm or less, it can be determined that no copper concentration peak 73 is present. When there is no copper concentration peak 73, no first intermediate region 401 is present, either. In FIG. 7, the direction toward the dielectric layer 11 is the direction indicated by the block arrow E.

Therefore, the copper concentration at the copper concentration peak 73 is 1.5 or more times the average value of the copper concentration in the region apart from the first boundary part 72 in the direction toward the dielectric layer 11 by +0.5 nm or greater and +2 nm or less (hereinafter, also referred to as “copper concentration reference region”) in the region 70.

That is, when the copper concentration at the copper concentration peak 73 is 1.5 or more times the average value of the copper concentration in the copper concentration reference region, this means that copper is particularly unevenly distributed in the first intermediate region 401. Therefore, even if many oxygen deficiencies move close to the first intermediate region 401, it is considered that copper supplies oxygen to the oxygen deficiencies, and that the oxygen deficiency concentration (oxygen deficiency density) near the first intermediate region 401 can be prevented from becoming high. As a result, occurrence of insulation deterioration can be inhibited in particular, and the lifetime of the multilayer ceramic capacitor 100 can be improved.

The B-site element also functions as an oxygen supplier. Therefore, when the copper concentration at the position of the copper concentration peak 73 is defined as C(Cu), the concentration of the B-site element is defined as C(B), and the concentration of the A-site element is defined as C(A), it is preferable that a concentration C calculated by the following formula (1) is 10 at % or greater and less than 35 at %.

$$C = C ( Cu ) + C ( B ) - C ( A ) \qquad ( 1 )$$

Although the B-site element contained in the first intermediate region 401 functions as an oxygen supplier, for example, the B-site element of the dielectric material contained in the dielectric layer 11 is considered to not substantially function as an oxygen supplier.

Therefore, it is possible to inhibit the occurrence of insulation deterioration, particularly by adjusting the concentration C, which is the total of the copper concentration C(Cu) at the position of the copper concentration peak 73 and the concentration C(B)-C(A), which corresponds to the concentration of the B-site element that is considered to function as an oxygen supplier, to be 10 at % or greater. Therefore, the lifetime of the multilayer ceramic capacitor 100 can be improved.

However, because the effect of inhibiting the occurrence of insulation deterioration is saturated when the concentration C is increased excessively, the concentration C can be less than 35 at %.

### (Second Intermediate Regions)

The multilayer ceramic capacitor 100 of this embodiment can further include second intermediate regions 402 between the first intermediate regions 401 and the internal electrode layers 12.

When the multilayer ceramic capacitor 100 of this embodiment includes the first intermediate regions 401, the joining strength between the dielectric layers 11 and the internal electrode layers 12 can be enhanced. Therefore, even when an external force is applied to the multilayer ceramic capacitor 100, it can avoid breakage or the like.

Although the reason for this is not clear, it is considered that the B-site element and copper contained in the first intermediate region 401 fill any voids or the like generated between the dielectric layer 11 and the internal electrode layer 12, and the joining strength between the layers can be enhanced.

Furthermore, because the multilayer ceramic capacitor 100 of the present embodiment includes the second intermediate regions 402, it is considered possible to make the compositional change from the dielectric layer 11 to the internal electrode layer 12 particularly mild. Therefore, it is considered that an interface or the like that considerably weakens the joining strength can hardly be generated between the dielectric layer 11 and the internal electrode layer 12, and the joining strength between the dielectric layer 11 and the internal electrode layer 12 can be enhanced.

The composition of the second intermediate region 402 is not particularly limited, and the second intermediate region 402 may include some or all of the components contained in the first intermediate region 401, the internal electrode layer 12, and the dielectric layer 11.

### (Dielectric Layers)

The dielectric layers 11 are parts that contain a perovskite structure represented by the general formula ABO_{3-α} (0≤α≤1) as a main component of the dielectric material. The dielectric layer 11 may or does not need to be adjacent to the first intermediate region 401.

The concentrations of the elements contained in each layer or region, when determined by an energy dispersive X-ray (EDX) analysis using a transmission electron microscope (TEM)/scanning transmission electron microscope (STEM), may include concentrations of any elements contained in any parts other than that layer or region concerned that is contained in the sample. Therefore, the analytical accuracy may be low when the quantification is performed by the above-described analytical method. This is because when preparing a sample for TEM/STEM observation, a thin piece is obtained from the sample, and this may arouse a possibility that any part that is not the layer or region to be evaluated may be included on the back surface or the like of the sample, to make it impossible to accurately evaluate the layer or region to be evaluated. For example, use of a TEM/STEM-EDX analysis is not a problem when measuring apparently a large-size evaluation region. However, for an accurate analysis of the content ratio of the elements contained in such a layer or region as the first intermediate region 401, concentrations determined by a three-dimensional atom probe analysis are used.

### [Method of Producing Multilayer Ceramic Capacitor]

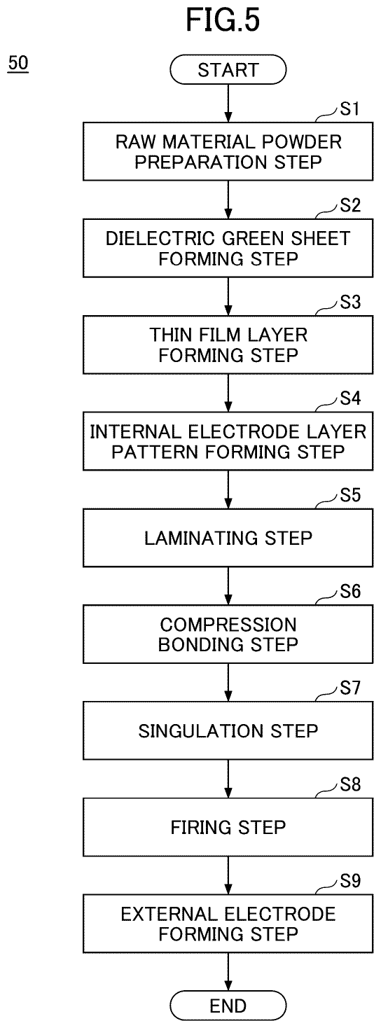

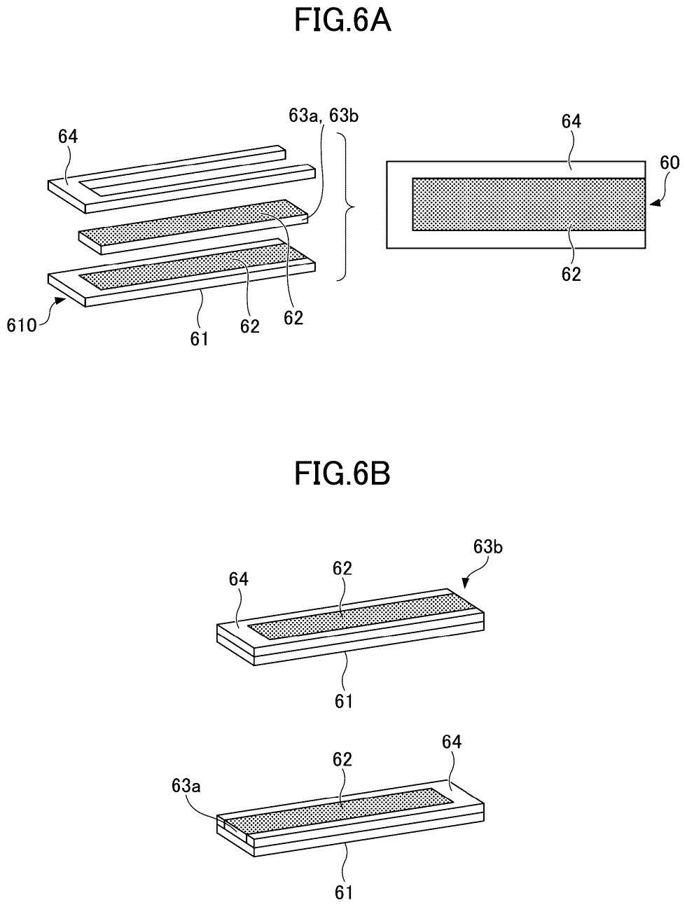

Next, a method of producing a multilayer ceramic capacitor 100 will be described. FIG. 5 is a flowchart 50 illustrating a method of producing the multilayer ceramic capacitor 100. FIG. 6 is a diagram illustrating the method of producing the multilayer ceramic capacitor 100.

The method of producing the multilayer ceramic capacitor of this embodiment may include a dielectric green sheet forming step, a thin film layer forming step, an internal electrode layer pattern forming step, and a firing step. The method of producing the multilayer ceramic capacitor of this embodiment, including any optional steps other than those described above, will be described below.

### (1) Raw Material Powder Preparation Step (S1)

In the raw material powder preparation step, first, a dielectric material for forming the dielectric layer 11 is prepared.

The dielectric layer 11 of the multilayer ceramic capacitor 100 produced by the method of producing the multilayer ceramic capacitor of this embodiment can contain a dielectric material having a perovskite structure represented by the general formula ABO_{3-α} (0≤α≤1). Since the dielectric material having the perovskite structure represented by the general formula ABO_{3-α} (0≤α≤1) has already been described, description thereof will be omitted.

The A-site element and the B-site element contained in the dielectric layer 11 are typically contained in the dielectric layer 11 in the form of sintered particles of ABO_{3-α} (0≤α≤1). For example, barium titanate is a tetragonal crystal compound having a perovskite structure and exhibits a high relative permittivity. Typically, it is possible to obtain barium titanate by reacting a titanium raw material such as titanium dioxide or the like with a barium raw material such as barium carbonate or the like. Various methods have been known as a method for synthesizing the main component ceramic of the dielectric layer 11, such as solid-phase methods, sol-gel methods, hydrothermal methods, and the like. In the present embodiment, any of these can be employed.

In the raw material powder preparation step, as an additive, an additive element simple substance or a compound containing the additive element can be added to the obtained ceramic raw material powder. In addition, a predetermined additive compound can further be added to the obtained ceramic raw material powder according to the purpose. Examples of the additive compound include oxides containing one or more elements selected from zirconium (Zr), magnesium (Mg), manganese (Mn), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)), oxides containing one or more elements selected from cobalt (Co), nickel (Ni), lithium (Li), boron (B), sodium (Na), potassium (K), and silicon (Si), and glasses containing one or more elements selected from cobalt, nickel, lithium, boron, sodium, potassium, and silicon.

The B-site element contained in the first intermediate region 401 is considered to be mainly derived from the B-site element contained in the dielectric green sheet serving as the dielectric layer 11. The B-site element contained in the first intermediate region 401 may be derived from the B-site element contained in the dielectric material. However, in order to reduce B-site element deficiency in the dielectric material, the raw material powder may contain a B-site element-containing component that may undergo diffusion into the first intermediate region 401 and the like as an additive component. Examples of the B-site element-containing component contained in the raw material powder used for producing the dielectric layer 11 include a B-site element simple substance, a B-site element-containing compound, and the like.

Examples of the dielectric material contained in the dielectric layer 11 include barium titanate, and the like. In this case, the B-site element is titanium. Therefore, for example, a titanium-containing component, which is a B-site element-containing component, can be added to the dielectric green sheet as an additive component. Examples of the titanium-containing component include titanium dioxide (TiO₂), a titanium simple substance, and the like. In particular, a titanium-containing compound, which is a compound containing titanium, can be suitably used.

The ceramic material can be prepared by, for example, mixing the additive containing the additive element, the additive compound, and the B-site element-containing component with the ceramic raw material powder in a wet manner, and drying and grinding the mixture. For example, as needed, the ceramic material obtained in the way described above may be subjected to a grinding treatment to adjust the particle diameter, or further to a classification treatment in combination to adjust the particle diameter. The raw material powder, which is the dielectric material, can be obtained by the above steps.

### (2) Dielectric Green Sheet Forming Step (S2)

In the dielectric green sheet forming step, a binder such as polyvinyl butyral (PVB) resin, or the like, an organic solvent such as ethanol, toluene, or the like, and a plasticizer can be added to the raw material powder obtained in the raw material powder preparation step and mixed in a wet manner. The binder and the like may be added and mixed in a wet manner when mixing the ceramic raw material powder and the like in the raw material powder preparation step (S1).

In the dielectric green sheet forming step, the obtained slurry can be applied to a substrate by, for example, a die coater method or a doctor blade method, and dried to form a dielectric green sheet 61. The substrate is, for example, a polyethylene terephthalate (PET) film. A diagram illustrating the dielectric green sheet forming step is omitted.

Thus, in the dielectric green sheet forming step (S2), a dielectric green sheet containing the dielectric material having the perovskite structure represented by the general formula ABO_{3-α} (0≤α≤1) can be formed.

As described in the raw material powder preparation step (S1), the raw material powder may also contain a B-site element-containing component. Therefore, the dielectric green sheet formed using the raw material powder may also contain the B-site element-containing component, such as a titanium-containing compound, in addition to the dielectric material having the perovskite structure represented by the general formula.

The ratio of the number of moles of the B-site element of the dielectric material having the perovskite structure to the number of moles of the A-site element of the dielectric material having the perovskite structure contained in the dielectric green sheet may be 1.001 or greater and 1.005 or less. The ratio of the number of moles of the B-site element to the number of moles of the A-site element contained in the dielectric material having the perovskite structure represented by the general formula ABO_{3-α} (0≤α≤1) is 1.0 in terms of the stoichiometric ratio. Therefore, the ratio of the number of moles of the B-site element to the number of moles of the A-site element in the dielectric green sheet being 1.001 or greater means that the dielectric green sheet contains the B-site element derived from the added B-site element-containing component in addition to the B-site element contained in the dielectric material. Therefore, the first intermediate region 401 can be easily formed between the dielectric layer 11 and the internal electrode layer 12 through the firing step (S8) described later.

In addition, when the ratio of the number of moles of the B-site element to the number of moles of the A-site element contained in the dielectric green sheet is greater than 1.005, there is a risk that the concentration of the B-site element in the dielectric layer 11 becomes high, and the dielectric properties of the dielectric layer may be affected. Therefore, it is preferable that the ratio of the number of moles of the B-site element to the number of moles of the A-site element contained in the dielectric green sheet is 1.005 or less.

### (3) Thin Film Layer Forming Step

In the thin film layer forming step (S3), as shown in FIG. 6A, a thin film layer 62 containing copper can be formed on a surface of the dielectric green sheet 61 by sputtering or vapor deposition to produce a dielectric material-thin film layer sheet 610.

The thin film layer 62 formed in the thin film layer forming step (S3) serves as a copper source contained in the first intermediate region 401 and the second intermediate region 402.

The composition of the thin film layer 62 is not particularly limited, and may be, for example, a layer containing copper oxide (CuO).

In order to adjust the content of copper contained in the thin film layer 62, the thin film layer 62 may contain copper and nickel, which is a metal contained in the internal electrode layer 12.

The concentration of copper contained in the thin film layer is not particularly limited, and can be selected in accordance with the copper concentration required in the first intermediate region 401 and the like. For example, the concentration of copper contained in the thin film layer 62 is preferably 1 at % or greater and 6 at % or less with respect to nickel contained in an internal electrode layer pattern described later.

It is preferable that the thin film layer 62 is formed on at least a part of the surface of the dielectric green sheet 61 on which the internal electrode layer is formed, and may be formed on an entire surface of the dielectric green sheet 61 on which the internal electrode layer is formed.

The thin film layer forming step may be further performed after the internal electrode layer pattern forming step (S4) to form a thin film layer on a surface of the internal electrode layer pattern. Therefore, for example, the step of forming a thin film layer on the surface of the dielectric green sheet 61 may be described as the first thin film layer forming step, and the step of forming a thin film layer on the surface of the internal electrode layer pattern may be described as the second thin film layer forming step.

The second thin film layer forming step may be performed in the same manner as the first thin film layer forming step except that a thin film layer is formed on the surface of the internal electrode layer pattern. Thin film deposition conditions may be the same or different in the first thin film layer forming step and the second thin film layer forming step.

### (4) Internal Electrode Layer Pattern Forming Step (S4)

The first internal electrode layer 12a and the second internal electrode layer 12b may mainly consist of a base metal such as nickel (Ni), copper, (Cu), tin (Sn), or the like, or a nickel alloy containing these metals. Base metals such as copper (Cu), tin (Sn), or the like may be added as additives.

A metal conductive paste for forming the precursor of the first internal electrode layer 12a and the second internal electrode layer 12b can be prepared by, for example, kneading nickel, other metal components, an organic binder, a solvent, and the like. Nickel may be added in a simple substance state or in a compound state.

In the internal electrode layer pattern forming step, as illustrated in FIG. 6A, the metal conductive paste for forming the internal electrode layer pattern containing the organic binder can be printed on a surface of the thin film layer 62 of the dielectric material-thin film layer sheet 610 by screen printing, gravure printing, or the like. Thus, a first internal electrode layer pattern 63a for the first internal electrode layer 12a or a second internal electrode layer pattern 63b for the second internal electrode layer 12b is placed on the surface of the dielectric material-thin film layer sheet 610. Ceramic particles may be added to the metal conductive paste as a co-existent material. The main component of the ceramic particles is not particularly limited, but is preferably the same as the main component ceramic of the dielectric layer 11. When adding ceramic particles as a co-existent material, they can be added in the kneading of the metal conductive paste. The method for forming the internal electrode layer is not limited to printing, and plating, vacuum vapor deposition, sputtering, or CVD may be used.

Therefore, in the internal electrode layer pattern forming step (S4?), an internal electrode layer pattern containing nickel as a main component can be formed on the thin film layer 62 of the dielectric material-thin film layer sheet 610, to produce the ceramic green sheet 60.

Moreover, a dielectric pattern paste for a reverse pattern layer can be obtained by adding a binder such as ethyl cellulose or the like and an organic solvent such as terpineol or the like to the raw material powder, which is the dielectric material obtained in the raw material powder preparation step (S1), and kneading them using a roll mill. Then, as illustrated in FIG. 6A, a dielectric pattern 64 may be placed on the dielectric material-thin film layer sheet 610 by printing the dielectric pattern paste on a peripheral region where no internal electrode layer pattern is printed, to fill the gap from the internal electrode layer pattern. The dielectric green sheet 61 on which the internal electrode layer pattern and the dielectric pattern 64 are printed is referred to as a lamination unit.

### (5) Laminating Step (S5)

In the laminating step (S5), as illustrated in FIG. 6B, the lamination units can be laminated such that the internal electrode layers and the dielectric layers are alternate and such that the edges of the internal electrode layers are exposed to the end surfaces of the dielectric layers on alternate sides in the length direction and drawn out to alternate ones of a pair of external electrodes. Specifically, a dielectric green sheet 61 on which the first internal electrode layer pattern 63a and the dielectric pattern 64 are printed and a dielectric green sheet 61 on which the second internal electrode layer pattern 63b and the dielectric pattern 64 are printed are laminated in this order. For example, the number of lamination units to be laminated can be set to 100 to 500 layers.

### (6) Compression Bonding Step (S6)

In the compression bonding step, the laminate in which the lamination units are laminated can be thermocompression-bonded, with a predetermined number of, for example, 2 to 10 layers of cover sheets laminated on top and bottom of the laminate.

### (7) Singulation Step (S7)

In the singulation step, the compression-bonded body obtained by the compression bonding can be singulated into individual pieces. Existing methods such as dicing by a dicer, laser cutting, and the like can be used appropriately for singulation.

### (8) Firing Step (S8)

In the firing step, the laminates singulated into individual pieces, i.e., the laminates in which the ceramic green sheets are laminated are subjected to a degreasing treatment and fired. In the firing step, the degreasing treatment and the firing treatment may be performed continuously or separately. Conditions for degreasing and firing are not particularly limited.

For example, degreasing may be performed in a nitrogen atmosphere at 250° C. or higher and 500° C. or lower.

Firing can be carried out in a weakly reducing atmosphere at an oxygen partial pressure of 2.7×10⁻⁹ atm or higher and 5.0×10⁻⁸ atm or lower. The temperature range of the firing temperature can be 1,100° C. or higher and 1,350° C. or lower.

The firing temperature range can be 1,150° C. or higher and 1,350° C. or lower.

If necessary, after firing under the above firing conditions, a re-oxidation treatment can be carried out in a nitrogen atmosphere at 600° C. or higher and 1,000° C. or lower.

It is preferable to raise the temperature at a temperature raising rate of 15,000° C./h or greater until the firing temperature is reached. The retention time at the firing temperature is preferably 5 minutes or longer and 10 minutes or shorter.

By adjusting the temperature raising rate to 15,000° C./h or greater and adjusting the retention time at the firing temperature to 5 minutes or longer and 10 minutes or shorter, it is possible to inhibit copper contained in the thin film layer from being excessively diffused into other layers.

Depending on the temperature raising rate, the retention time at the firing temperature, and the firing temperature, it is possible to select the size of the first intermediate region 401, the presence or absence of the second intermediate region 402, and the like.

The upper limit of the temperature raising rate is not particularly limited, yet it is preferable to adjust it to less than, for example, 18,000° C./h, from the viewpoint of reducing damage to the firing furnace.

### (9) External Electrode Forming Step (S9)

In the external electrode forming step, an external electrode can be formed by forming a pattern of a metal conductive paste for forming the external electrode layer, containing a metal such as nickel, copper, or the like and an organic binder, by screen printing, dipping, or the like, and baking the pattern. The method for forming the external electrode is not limited to printing or dipping, and plating, vacuum vapor deposition, sputtering, or CVD may be used. The external electrode may be formed by forming a conductive resin paste by screen printing, dipping, or the like, and curing the resin. If necessary, a layer of copper, nickel, or tin may be formed by plating or the like. Thus, the first external electrode 20a and the second external electrode 20b can be formed. The multilayer ceramic capacitor 100 is completed through the above steps.

The above steps are examples, and the method for producing the multilayer ceramic capacitor of the present embodiment is not limited to the above-described mode. For example, an underlayer of the external electrodes can be provided on the surface of a laminate that is singulated into an individual piece, and baked at the same time as firing the ceramic. In this way, the underlayer of the external electrodes can be formed. In this case, in the external electrode forming step after the firing step, the external electrodes can be completed by forming a layer of copper, nickel, or tin on the underlayer by plating.

### Other Embodiments

Although the above-described embodiment has been described in detail, the present disclosure is not limited to the specific embodiment, and various modifications and changes are applicable within the scope of description in the claims.

For example, although the above embodiment is applied to a multilayer ceramic capacitor having two terminal electrodes as external electrodes, it may be applied to a multilayer ceramic capacitor having three or more terminals.

In the above embodiment, a multilayer ceramic capacitor is described as an example of the multilayer ceramic electronic component. However, the present disclosure is applicable to multilayer ceramic electronic components in general. Examples of such multilayer ceramic electronic components include chip varistors, chip thermistors, multilayer inductors, and the like.

### EXAMPLES

Specific examples will be described below, but the present disclosure is not limited to these examples.

### (1) Evaluation Method

### (1-1) Three-Dimensional Atom Probe Analysis

When performing a three-dimensional atom probe analysis, needle-shaped samples having a tip diameter of 50 nm or greater and 100 nm or less and including approximately the interface between the dielectric layer 11 and the internal electrode layer 12 were produced by FIB processing based on multilayer ceramic capacitors produced in each Example and Comparative Example. Then, a high electric field was applied to the tip of the needle-shaped sample, and a laser pulse was applied, to ionize the sample surface, and analyze the atomic distribution by a secondary detector. In this way, the three-dimensional atom probe analysis was performed.

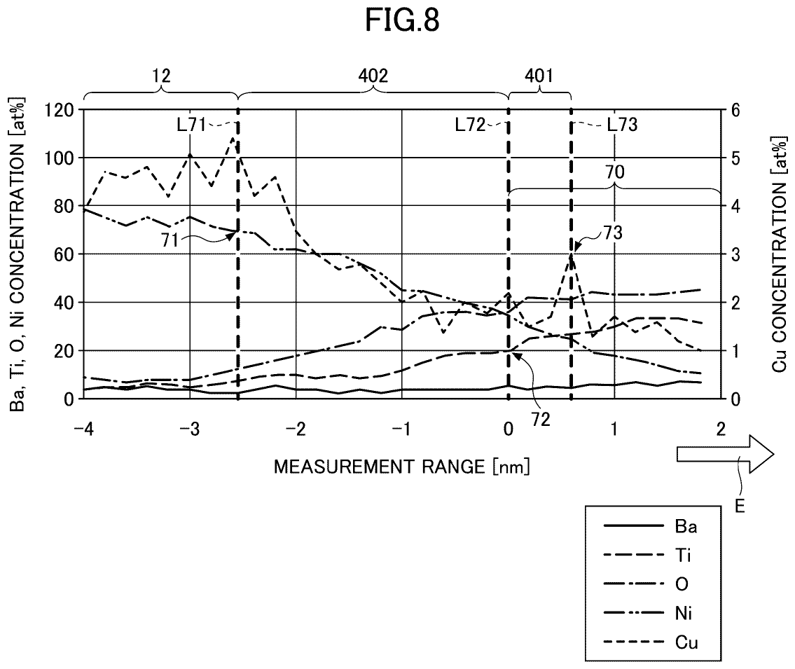

A LEAP5000XS (obtained from AMETEK, Inc.) was used as the three-dimensional atom probe analysis device. The wavelength of the laser pulse applied to the needle-shaped sample was 355 nm. FIGS. 7 and 8 show the measurement results of Examples 2 and 9.

The concentrations of the respective elements, as the measurement results, were calculated such that the total of Ba, Ti, O, Cu, and Ni, which were the elements detected by the three-dimensional atom probe analysis, would be 100 at %. FIGS. 7 and 8 show examples of the measurement results regarding measurement position-dependent changes in the concentrations of the elements obtained by the three-dimensional atom probe analysis (hereinafter, also referred to as “measurement results”).

Then, each layer was identified based on the obtained measurement results.

Specifically, as shown in FIGS. 7 and 8, regarding a straight line L71 passing through a point 71 at which the nickel concentration was 70 at % as a boundary line, a region in which the nickel concentration was 70 at % or greater was determined as the internal electrode layer 12.

In a region 70 in which the nickel concentration was less than 70 at % and the concentration of titanium as the B-site element was 20 at % or greater, a region sandwiched between a first boundary part 72 at which the titanium concentration was 20 at % and a second boundary part at which a copper concentration peak 73 appeared was determined as the first intermediate region 401. That is, as shown in FIGS. 7 and 8, the first intermediate region 401 was determined as a region sandwiched between a straight line L72 passing through the first boundary part 72 at which the titanium concentration was 20 at % and a straight line L73 passing through the second boundary part at which the copper concentration peak 73 appeared.

In addition, a region between the internal electrode layer 12 and the first intermediate region 401, that is, a region in which the nickel concentration was less than 70 at % and the titanium concentration was less than 20 at %, was determined as the second intermediate region 402.

As a method for evaluating the structure near the interface between the dielectric layer 11 and the internal electrode layer 12 in each Example, the presence or absence of the first intermediate region 401 was determined first. That is, it was determined whether or not there was a copper concentration peak 73 in the region 70. When there was a copper concentration peak 73, it was determined that there was a first intermediate region 401. When there was no copper concentration peak 73, it was determined that there was no first intermediate region 401. The evaluation result is shown in the “Pres. or abs. of 1^{st} interm. region” field of Table 1.

The presence/absence of the copper concentration peak 73 was determined by the following procedure. From the above measurement results, the point at which the Cu concentration assumed the maximum value in the above region 70 was extracted. When the Cu concentration at the point at which the Cu concentration assumed the maximum value was higher than 1.5 times the average Cu concentration at a measurement point included in a range of +0.5 nm or greater and +2 nm or less from the first boundary part 72 in a direction toward the dielectric layer 11 indicated by the block arrow E, the point at which the Cu concentration assumed the maximum value was determined as a copper concentration peak 73. The measurement point included in the range of +0.5 nm or greater and +2 nm or less from the first boundary part 72 in the direction toward the dielectric layer 11 means a measurement point whose measurement position with respect to the position of the first boundary part 72 was located on the dielectric layer 11 side in a range from a point that was apart by 0.5 nm until a point that was apart by 2.0 nm from the first boundary part 72.

Table 1 shows the copper concentration at the copper concentration peak 73 in the first intermediate region in the “Copper conc. at Cu conc. peak” field.

In addition, when the copper concentration at the copper concentration peak 73 was defined as C(Cu), the B-site element concentration was defined as C(B), and the A-site element concentration was defined as C(A), a concentration C that can be calculated by the following formula (1) was calculated and shown in the “Conc. C” field of Table 1.

$$C = C ( Cu ) + C ( B ) - C ( A ) \qquad ( 1 )$$

In the following Examples and Comparative Examples, since barium titanate was used as a dielectric material, the A-site element was barium and the B-site element was titanium. Therefore, the above formula (1) can be expressed as C═C(Cu)+C(Ti)—C(Ba). In Table 1, the value of C(Ti)—C(Ba) is also shown in the “C(Ti)—C(Ba)” field.

Since there was a possibility that the titanium concentration at the copper concentration peak 73 may include titanium derived from barium titanate (BaTiO₃) contained in the dielectric layer 11 as a dielectric material, the value obtained by subtracting the barium concentration from the titanium concentration as described above is used.

### (1-2) Accelerated Life Test

Fifty samples were prepared for each of the multilayer ceramic capacitors produced in Examples and Comparative Examples. An accelerated life test (HALT) of each selected sample was performed. In the accelerated life test, a voltage of 10 V was applied to each of the fifty samples, which were produced under the same conditions, in a thermostatic bath at 125° C., and the time taken until insulation deterioration occurred was measured.

During the evaluation, dielectric resistance was measured, and when the dielectric resistance value became less than 1 MΩ, insulation deterioration was judged to occur.

The average value of the time taken until the fifty samples evaluated underwent insulation deterioration was evaluated as the time taken until insulation deterioration occurred, that is, the lifetime, of the samples of each Example and Comparative Example.

The evaluation results are shown in the “Lifetime” field in Table 1. The greater the value, the better the lifetime characteristics.

When the lifetime evaluation was 500 minutes or longer, the lifetime judgment was evaluated as “A”. When the lifetime evaluation was shorter than 500 minutes, the lifetime judgment was evaluated as “B”.

When the lifetime judgment was A, the multilayer ceramic capacitor concerned can be judged as having excellent lifetime characteristics.

### (1-3) Bending Test

A bending test was performed based on JEITA, AEC-Q200 REV E-Standard, Passive Element Reliability Conformity Test Guide, Printed Board Bending Resistance Test.

The bending test was performed by mounting the multilayer ceramic capacitor produced in each Example and Comparative Example as a sample chip on a test substrate, deforming the test substrate to a bending depth of 2 mm in a direction perpendicular to a surface of the sample on which the sample was mounted on the substrate, and releasing the sample from the bending force. After that, the sample chip was embedded in a resin, a cross-section was polished, and the presence or absence of any interlayer fracture between the dielectric layer and the internal electrode layer was confirmed using an electron microscope. The electron microscope observation was performed at a magnification of ×1,000, and the entire cross-section of the sample of which the cross-section was polished was observed to confirm the presence or absence of any interlayer fracture in the cross-section.

In each Example and Comparison Example, fifty sample chips were evaluated, and the number of sample chips in which interlayer fracture occurred between the dielectric layer and the internal electrode layer was counted.

As the test substrate on which the sample chip was mounted, an FR4 substrate having a thickness of 1.6±0.2 mm (including a copper foil thickness), a copper foil thickness of 35±10 μm, and contour dimensions of 100 mm×40 mm was used.

### (1-4) Comprehensive Judgment

When the lifetime judgment was A and the number of sample chips in which interlayer fracture occurred between the dielectric layer and the internal electrode layer after the bending test was 5 or less, the multilayer ceramic capacitor concerned was evaluated as “A”, which means having excellent lifetime characteristics and excellent interlayer junction strength. When the above-described requirements for the A evaluation were not satisfied, the multilayer ceramic capacitor concerned was evaluated as “B”, which means being poor at either the lifetime characteristics or the interlayer junction strength.

### (2) Sample Preparation Conditions

### Example 1

A multilayer ceramic capacitor was produced according to the flowchart 50 shown in FIG. 5.

Specifically, first, powders of barium titanate (BaTiO₃) as a dielectric material, titanium dioxide (TiO₂) as a titanium-containing compound, and a rare earth oxide, SiO₂, and MgO as other additives, and organic solvents (ethanol and toluene) were mixed and ground using zirconia beads having a diameter of 1 mm. Then, a binder (PVB) was added to the mixed and ground product to obtain a slurry (raw material powder preparation step). When preparing the raw material powder, the mixing ratio of barium titanate and titanium dioxide was adjusted such that the titanium concentration to the barium concentration in the dielectric green sheet and in the dielectric layer 11 would be the value shown in the “Ti/Ba ratio in diel. layer” field of Table 1 in terms of ratio by number of moles.

The obtained slurry was applied to a substrate film, and the slurry applied to the substrate film was dried to obtain a dielectric green sheet having a thickness of 0.7 μm (dielectric green sheet forming step).

By a vapor deposition method, a thin film layer of copper oxide (CuO) was formed on a part of the surface of the dielectric green sheet on which an internal electrode layer pattern was to be formed, to produce a dielectric material-thin film layer sheet (first thin film layer forming step).

In the first thin film layer forming step, the thin film layer was formed such that the ratio of the copper concentration in the thin film layer to nickel to be contained in the internal electrode layer pattern would be 1 at %, which is the value shown in the “Copper conc. in TF layer” field of Table 1.

A metal conductive paste containing nickel was printed on the part of the dielectric material-thin film layer sheet on which the thin film layer was formed, to form an internal electrode layer pattern containing nickel in each dielectric material-thin film layer sheet (internal electrode layer forming step). Furthermore, a thin film layer of copper oxide (CuO) was also formed by a vapor deposition method on the surface of the internal electrode layer pattern, to produce a ceramic green sheet serving as a lamination unit (second thin film layer forming step). The second thin film layer was formed under the same conditions as the first thin film layer except that the film was formed on the surface of the internal electrode layer pattern.

The ceramic green sheet includes the dielectric green sheet and the internal electrode layer pattern formed on the surface of the dielectric green sheet, and the thin film layers are provided on the upper and lower surfaces of the internal electrode layer pattern.

Next, ten lamination units were laminated to form a laminate (laminating step).

The laminate was compression-bonded, and then singulated into individual pieces, to obtain green laminates having a chip shape (compression bonding step and singulation step).

Next, the green laminate having the chip shape was degreased in a nitrogen atmosphere. Then, the green laminate having the chip shape after the degreasing treatment was put into a firing furnace and fired (firing step). In the firing step, the temperature was raised to 1, 200° C. at a temperature raising rate of 15,000° C./h and retained at the firing temperature of 1,200° C. for 300 seconds. The firing was carried out in a weakly reducing atmosphere at an oxygen partial pressure of 5.0×10-8 atm.

The first external electrode 20a and the second external electrode 20b were formed on the fired laminate by plating treatment (external electrode forming step).

The obtained multilayer ceramic capacitor had a chip shape of 1.0 mm×0.5 mm×0.5 mm, a dielectric layer 11 thickness of 0.7 μm, and an internal electrode layer 12 thickness of 0.7 μm, and 350 layers were laminated. The thickness of the dielectric layer 11 and the internal electrode layer 12 was evaluated according to the procedure described above.

The evaluations described above were performed for the obtained multilayer ceramic capacitor. The evaluation results are shown in Table 1.

### Examples 2 to 10

When preparing the raw material powder, the mixing ratio between barium titanate and titanium dioxide was adjusted such that the titanium concentration with respect to the barium concentration in the dielectric green sheet and the dielectric layer 11 would become the value shown in the “Ti/Ba ratio in diel. layer” field of Table 1 in the dielectric layer forming step. In addition, when forming the thin film layer, the copper concentration in the thin film layer with respect to nickel contained in the internal electrode layer pattern was adjusted to become the value shown in the “Copper conc. in TF layer” field of Table 1.

Multilayer ceramic capacitors were produced under the same conditions and procedures as in Example 1 except for the above points, and evaluated. The evaluation results are shown in Table 1.

### Comparative Example 1

The first thin film layer forming step and the second thin film layer forming step were not performed.

Multilayer ceramic capacitors were produced under the same conditions and procedures as in Example 1 except for the above point, and evaluated. The evaluation results are shown in Table 1.

### Comparative Examples 2 to 6

When preparing the raw material powder, the mixing ratio between barium titanate and titanium dioxide was adjusted such that the titanium concentration with respect to the barium concentration in the dielectric layer 11 would become the value shown in the “Ti/Ba ratio in diel. layer” field of Table 1 in the dielectric layer forming step. In addition, when forming the thin film layer, the ratio of the copper concentration in the thin film layer with respect to nickel contained in the internal electrode layer pattern was adjusted to become the value shown in the “Copper conc. in TF layer” field of Table 1.

Multilayer ceramic capacitors were produced under the same conditions and procedures as in Example 1 except for the above points, and evaluated. The evaluation results are shown in Table 1.

### Comparative Example 7

The firing step was performed using, as a firing atmosphere, a strongly reducing atmosphere at an oxygen partial pressure of 1.0×10-9 atm.

A multilayer ceramic capacitor was produced under the same conditions and procedures as in Example 1 except for the above point, and evaluated. The evaluation results are shown in Table 1.

TABLE 1

| | | | | Copper | | | | | | |
|---|---|---|---|---|---|---|---|---|---|---|
| | | | Pres. or | conc. at | | | | | Number of chips found to | |
| | Copper conc. | Ti/Ba ratio | abs. of 1^{st} | Cu conc. | | Conc. | Life- | Life- | have interlayer fracture | |
| | in TF layer | in diel. | interm. | peak | C(Ti)—C(Ba) | C | time | time | after bending test | Compr. |
| | at % | layer | region | at % | at % | at % | min | JDG. | Chips | JDG. |
| Ex. 1 | 1 | 1.003 | Present | 1 | 22 | 23 | 900 | A | 0 | A |
| Ex. 2 | 2 | 1.003 | Present | 1.2 | 22 | 23 | 1,000 | A | 0 | A |
| Ex. 3 | 3 | 1.003 | Present | 1.4 | 21 | 22 | 1,100 | A | 0 | A |
| Ex. 4 | 4 | 1.003 | Present | 2 | 22 | 24 | 1,200 | A | 0 | A |
| Ex. 5 | 5 | 1.003 | Present | 2.5 | 28 | 31 | 1,200 | A | 0 | A |
| Ex. 6 | 1 | 1.001 | Present | 1.2 | 14 | 15 | 900 | A | 0 | A |
| Ex. 7 | 1 | 1.005 | Present | 1.2 | 29 | 30 | 800 | A | 0 | A |
| Ex. 8 | 4.5 | 1.001 | Present | 2.5 | 15 | 18 | 1,100 | A | 0 | A |
| Ex. 9 | 5 | 1.005 | Present | 3 | 22 | 25 | 1,300 | A | 0 | A |
| Ex. 10 | 6 | 1.003 | Present | 5 | 22 | 27 | 700 | A | 0 | A |
| Comp. | 0 | 1.003 | Absent | — | — | — | 200 | B | 50 | B |
| Ex. 1 | | | | | | | | | | |
| Comp. | 0.5 | 1.003 | Present | 0.5 | 21 | 22 | 300 | B | 12 | B |
| Ex. 2 | | | | | | | | | | |
| Comp. | 2 | 1.006 | Present | 1.2 | 34 | 35 | 300 | B | 20 | B |
| Ex. 3 | | | | | | | | | | |
| Comp. | 7 | 1.003 | Present | 6 | 23 | 29 | 400 | B | 0 | B |
| Ex. 4 | | | | | | | | | | |
| Comp. | 2 | 1.001 | Present | 1.2 | 4 | 5 | 300 | B | 30 | B |
| Ex. 5 | | | | | | | | | | |
| Comp. | 2 | 0.999 | Present | 1.2 | 2 | 3 | 300 | B | 28 | B |
| Ex. 6 | | | | | | | | | | |
| Comp. | 1 | 1.003 | Absent | — | — | — | 200 | B | 38 | B |
| Ex. 7 | | | | | | | | | | |

According to the results shown in Table 1, it was confirmed that the multilayer ceramic capacitors of Examples 1 to 10 including a first intermediate region positioned between the dielectric layer 11 and the internal electrode layer 12, having a copper concentration of 1.0 at % or greater and 5.0 at % or less at the copper concentration peak, and having a concentration C of 10 at % or greater and less than 35 at % where the concentration C was calculated according to the formula (1) where C(Cu) represents the copper concentration at the copper concentration peak position, C(Ti) represents the titanium concentration, and C(Ba) represents the barium concentration, had excellent lifetime characteristics.

In addition, it was confirmed that the multilayer ceramic capacitors of Examples 1 to 10 had excellent interlayer junction strength between the dielectric layer 11 and the internal electrode layer 12, with a decrease in the occurrence of interlayer fractures through the bending test.

On the other hand, it was confirmed that Comparative Example 1 including no first intermediate layer was poor at both the lifetime and the interlayer junction strength between the dielectric layer 11 and the internal electrode layer 12.

It was confirmed that Comparative Example 2, in which, although formation of a first intermediate region was confirmed, the copper concentration at the copper concentration peak was low at 0.5 at %, was poor at both the lifetime and the interlayer junction strength between the dielectric layer 11 and the internal electrode layer 12.

It was confirmed that Comparative Example 3, in which, although formation of a first intermediate region was confirmed and the copper concentration at the copper concentration peak was sufficient at 1.2 at %, the concentration C was excessively high, was poor at both the lifetime and the interlayer junction strength between the dielectric layer 11 and the internal electrode layer 12.

In Comparative Example 4, although formation of a first intermediate region was confirmed, the copper concentration at the copper concentration peak was high at 6 at %. Therefore, it is considered that copper formed a solid solution in the titanium site of barium titanate, which was the dielectric material, in the dielectric layer 11, resulting in an increase in oxygen defects and a decrease in the lifetime.

In Comparative Examples 5 and 6, the formation of the first intermediate region was confirmed, and the copper concentration at the peak of the copper concentration was sufficient at 1.2 at %. However, since the concentration C was low, it is considered that the effect of eliminating oxygen defects was not sufficient, and that the lifetime decreased.

In Comparative Example 7, since firing was performed in a strongly reducing atmosphere, copper was reduced, resulting in formation of no first intermediate region, and segregation of copper in the internal electrode layer. Therefore, it was confirmed that both the lifetime and the interlayer junction strength between the dielectric layer 11 and the internal electrode layer 12 were poor.

Aspects of the present disclosure are, for example, as follows.

<1>A multilayer ceramic electronic component, including:
a plurality of dielectric layers laminated along a first axis and containing a dielectric material having a perovskite structure represented by a general formula ABO_{3-α} (0≤α≤1);
a plurality of internal electrode layers each positioned between those of the dielectric layers that are adjacent to each other along the first axis, the internal electrode layers containing nickel as a main component; and
first intermediate regions positioned between the dielectric layers and the internal electrode layers and containing copper,
wherein according to a three-dimensional atom probe analysis performed from the internal electrode layers to the dielectric layers along the first axis,
   the internal electrode layers are regions in which a nickel concentration is 70 at& or greater, and
   the first intermediate regions are regions that are included in a region in which the nickel concentration is less than 70 at % and a concentration of a B-site element of the general formula ABO_{3-α} (0≤α≤1) is 20 at % or greater, and that are sandwiched between a first boundary part at which the concentration of the B-site element is 20 at % and a second boundary part at which a peak of a copper concentration appears,
wherein the copper concentration at the peak of the copper concentration is 1.0 at % or greater and 5.0 at % or less, and
wherein a concentration C calculated by a formula (1) below is 10 at % or greater and less than 35 at %, where in the formula (1), C(Cu) represents the copper concentration at the peak of the copper concentration, C(B) represents the concentration of the B-site element, and C(A) represents a concentration of an A-site element of the general formula ABO_{3-α} (0≤α≤1).

$$C = C ( Cu ) + C ( B ) - C ( A ) \qquad ( 1 )$$

<2> The multilayer ceramic electronic component according to <1>,
wherein the copper concentration at the peak of the copper concentration is 1.5 or more times an average value of the copper concentration in a region that is apart from the first boundary part in a direction toward the dielectric layer by 0.5 nm or greater and 2 nm or less.
   <3> The multilayer ceramic electronic component according to <1> or <2>, further including second intermediate regions between the first intermediate regions and the internal electrode layers.
   <4> The multilayer ceramic electronic component according to any of <1> to <3>, wherein the dielectric layer contains barium titanate.
   <5>A method of producing a multilayer ceramic electronic component, the method including:
forming a dielectric green sheet containing titanium and barium;
forming a thin film layer containing copper on a surface of the dielectric green sheet by sputtering or vapor deposition, to form a dielectric material-thin film layer sheet;
forming an internal electrode layer pattern containing nickel as a main component on the thin film layer of the dielectric material-thin film layer sheet, to produce a ceramic green sheet; and
raising a temperature of a laminate in which the ceramic green sheet is laminated to a firing temperature of 1,150° C. or higher and 1,350° C. or lower at a temperature raising rate of 15,000° C./h or greater and less than 18,000° C./h in a weakly reducing atmosphere at an oxygen partial pressure of 2.7×10-9 atm or higher and 5.0×10-8 atm or lower, and retaining the laminate at the firing temperature for 5 minutes or longer and 10 minutes or shorter.
   <6> The method of producing a multilayer ceramic electronic component according to <5>,
wherein the thin film layer contains copper and nickel.
   <7> The method of producing a multilayer ceramic electronic component according to <5> or <6>,
wherein a concentration of copper contained in the thin film layer with respect to nickel contained in the internal electrode layer pattern is 1 at % or greater and 6 at % or less.
   <8> The method of producing a multilayer ceramic electronic component according to any one of <5> to <7>,
wherein the dielectric green sheet contains a titanium-containing compound in addition to a dielectric material having a perovskite structure.
   <9> The method of producing a multilayer ceramic electronic component according to any one of <5> to <8>,
wherein a ratio of a number of moles of titanium to a number of moles of barium contained in the dielectric green sheet is 1.001 or greater and 1.005 or less.

What is claimed is:

1. A multilayer ceramic electronic component, comprising:
a plurality of dielectric layers laminated along a first axis and containing a dielectric material having a perovskite structure represented by a general formula ABO_{3-α} (0≤α≤1);
a plurality of internal electrode layers each positioned between those of the dielectric layers that are adjacent to each other along the first axis, the internal electrode layers containing nickel as a main component; and
first intermediate regions positioned between the dielectric layers and the internal electrode layers and containing copper,
wherein according to a three-dimensional atom probe analysis performed from the internal electrode layers to the dielectric layers along the first axis,
the internal electrode layers are regions in which a nickel concentration is 70 at& or greater, and
the first intermediate regions are regions that are included in a region in which the nickel concentration is less than 70 at % and a concentration of a B-site element of the general formula ABO_{3-α} (0≤α≤1) is 20 at % or greater, and that are sandwiched between a first boundary part at which the concentration of the B-site element is 20 at % and a second boundary at which a peak of a copper concentration appears,
wherein the copper concentration at the peak of the copper concentration is 1.0 at % or greater and 5.0 at % or less, and
wherein a concentration C calculated by a formula (1) below is 10 at % or greater and less than 35 at %, where in the formula (1), C(Cu) represents the copper concentration at the peak of the copper concentration, C(B) represents the concentration of the B-site element, and C(A) represents a concentration of an A-site element of the general formula ABO_{3-α} (0≤α≤1),
$$C = C ( Cu ) + C ( B ) - C ( A ) . \qquad ( 1 )$$

2. The multilayer ceramic electronic component according to claim 1,
wherein the copper concentration at the peak of the copper concentration is 1.5 or more times an average value of the copper concentration in a region that is apart from the first boundary part in a direction toward the dielectric layer by 0.5 nm or greater and 2 nm or less.

3. The multilayer ceramic electronic component according to claim 1, further comprising
second intermediate regions between the first intermediate regions and the internal electrode layers.

4. The multilayer ceramic electronic component according to claim 1,
wherein the dielectric layer contains barium titanate.

5. A method of producing a multilayer ceramic electronic component, the method comprising:
forming a dielectric green sheet containing a dielectric material having a perovskite structure represented by a general formula ABO₃₋ₐ (0≤α≤1);
forming a thin film layer containing copper on a surface of the dielectric green sheet by sputtering or vapor deposition, to form a dielectric material-thin film layer sheet;
forming an internal electrode layer pattern containing nickel as a main component on the thin film layer of the dielectric material-thin film layer sheet, to produce a ceramic green sheet; and
raising a temperature of a laminate in which the ceramic green sheet is laminated to a firing temperature of 1,150° C. or higher and 1,350° C. or lower at a temperature raising rate of 15,000° C./h or greater and less than 18,000° C./h in a weakly reducing atmosphere having an oxygen partial pressure of 2.7×10-9 atm or higher and 5.0×10-8 atm or lower, and retaining the laminate at the firing temperature for 5 minutes or longer and 10 minutes or shorter.

6. The method of producing a multilayer ceramic electronic component according to claim 5,
wherein the thin film layer contains copper and nickel.

7. The method of producing a multilayer ceramic electronic component according to claim 5,
wherein a concentration of copper contained in the thin film layer with respect to nickel contained in the internal electrode layer pattern is 1 at % or greater and 6 at % or less.

8. The method of producing a multilayer ceramic electronic component according to claim 5,
wherein the dielectric green sheet contains a titanium-containing compound in addition to the dielectric material having the perovskite structure.

9. The method of producing a multilayer ceramic electronic component according to claim 5,
wherein a ratio of a number of moles of a B-site element of the dielectric material having the perovskite structure to a number of moles of an A-site element of the dielectric material having the perovskite structure contained in the dielectric green sheet is 1.001 or greater and 1.005 or less.
